(19) United States
(12) Patent Application Publication
(10) Pub. No.: US 2010/0098549 A1
(43) Pub. Date: Apr. 22, 2010

(54) Wind Turbine Blade

(76) Inventor: Gabriel Mironov, Taicang (CN)

Correspondence Address: Law Office of Michael D. Eisenberg;Intellectual Property Law, 3258 Caminito Eastbluff, Suite 89, San Diego, CA, 92037, US

(21) Appl. No.: 12/581,084

(22) Filed: Oct. 16, 2009

Related U.S. Application Data
(60) Provisional application No. 61/106,049, filed on Oct. 16, 2008.

(51) Int. Cl. F03D 11/00; B29C 65/18

(52) U.S. Cl. 416/229 R; 156/245

(57) ABSTRACT

A wind turbine blade having its main beam laminations formed from vinyl ester prepreg and a process from making same.

### CROSS-REFERENCES TO RELATED APPLICATIONS

This application claims priority from U.S. Provisional Application Ser. No. 61/106,049 filed Oct. 16, 2008, which is hereby incorporated herein by reference in its entirety.

### TECHNICAL FIELD

The present invention relates to a wind turbine blade and more particularly, some embodiments relate to a process and composition for forming the blade.

### BACKGROUND OF THE INVENTION

It is well known practice in the industry that a wind turbine blade may be formed by combination of glass, carbon or other fibers, wetted or impregnated with epoxy, polyester, or vinyl ester resin. Such impregnation or wetting may be done by pre-impregnation, hand lamination, or vacuum infusion. Many of these materials are either costly to use or have low fatigue resistance values. The present invention addresses these factors.

### BRIEF SUMMARY OF EMBODIMENTS OF THE INVENTION

According to one embodiment of the invention, a wind turbine blade having laminations formed from vinyl ester prepreg is provided.

In a variant, the wind turbine blade comprises a main beam section formed from vinyl ester prepreg.

In another variant, the wind turbine blade comprises a root area formed from vinyl ester prepreg.

In a further variant, the wind turbine blade comprises a main beam section and a root area both formed from vinyl ester prepreg.

In still another variant of the wind turbine blade, only the laminations forming the main beam of the blade are formed from vinyl ester prepreg.

In yet a further variant of the wind turbine blade, only the laminations forming the main beam of the blade are formed from vinyl ester prepreg and the remainder of the blade is produced by infusion with polyester resin.

In another variant of the wind turbine blade, the laminations are formed from vinyl ester prepreg filler fibers having at least an 80% by weight proportion of the fibers oriented within 5 degrees parallel to the blade axis.

In a further variant of the wind turbine blade, the vinyl ester prepreg material comprises between about 30% to about 70% of the total weight of the blade.

In still another variant, a process for forming a wind turbine blade comprises: curing a main beam of the blade formed form vinyl ester prepreg in a mold at a temperature in excess of one hundred degrees Celsius; and curing the rest of the blade not comprising the main beam in a larger mold below forty degrees C.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following FIGURE. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the FIGURE included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a cross section of a wind turbine blade in accordance with the principles of the invention.

The FIGURE are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The present invention provides a novel wind turbine blade having the heavily loaded main laminations of the blade formed from vinyl ester prepreg. Such vinyl ester prepreg may be used alone. However, in a preferred embodiment, a combination of vinyl ester prepreg with vinyl ester or polyester infusion is provided. This results in high fatigue resistance of the vinyl ester prepreg main laminations and easy processing by infusion of the aerodynamic shell.

If low cost unsaturated polyester resin is used for the aerodynamic shell, important cost reduction can be achieved by using the more expensive vinyl ester prepreg only for the critical portions of the blade. Also, the more expensive molds needed for prepreg processing may be reduced in width and overall size, being used only for an initial processing of the main lamination beam, rather than production of the entire blade.

It was an unexpected result that the novel vinyl ester prepreg developed for the low cost blade design exhibited outstanding fatigue resistance. In fact, the fatigue resistance of the unidirectional vinyl ester prepreg equals that of infused unidirectional laminate made with epoxy, and greatly exceeds that of infused laminate made with polyester.

The reason that high fatigue resistance of the vinyl ester prepreg material was not discovered previously is because such material has not been considered for wind power or other cyclic loading applications. Vinyl ester prepreg was exploited solely for consumer, recreational and military products, none of which required fatigue testing.

The improved fatigue resistance of the vinyl ester prepreg is believed to be due to the uniform dispersion of the fibers in the resin matrix, and the resulting even coating of each fiber with a film of the vinyl ester resin. Similar high fatigue performance has been noted for unidirectional glass/epoxy prepregs, however such glass/epoxy prepregs are much more expensive than the glass/vinyl ester prepregs.

As an added advantage, it was found that lower cost fiberglass fibers, with fiber coating “sizing” designed for polyester resins, was well suited for vinyl ester prepreg production. This results in further savings compared to epoxy blade production, which requires use of specialized glass rovings, with “epoxy-only sizing”, most notably Owens Corning SE1500.

The hybrid blade production technology suggested as a preferred embodiment offers a manner of upgrading existing epoxy infused blade designs, without substantially changing dimensions or weight of the product. This is in contrast to the commonly used polyester infused blades, which, while lower in cost, require increased cross section area of the main lamination and accordingly higher weight, owing to the poor fatigue performance of the polyester resin.

Additionally, the current invention allows the user to obtain a higher weight fraction of fiber in the blade lamination as compared to the infused epoxy or infused epoxy constructions, thus leading to both greater stiffness and lower cost than is possible with epoxy infusion technology.

The current technology of vinyl ester based prepreg may also be used as a lower cost replacement for epoxy based prepreg. It offers similar fatigue and static performance to the epoxy based prepreg and therefore eliminates any need for substantial redesign of the blade.

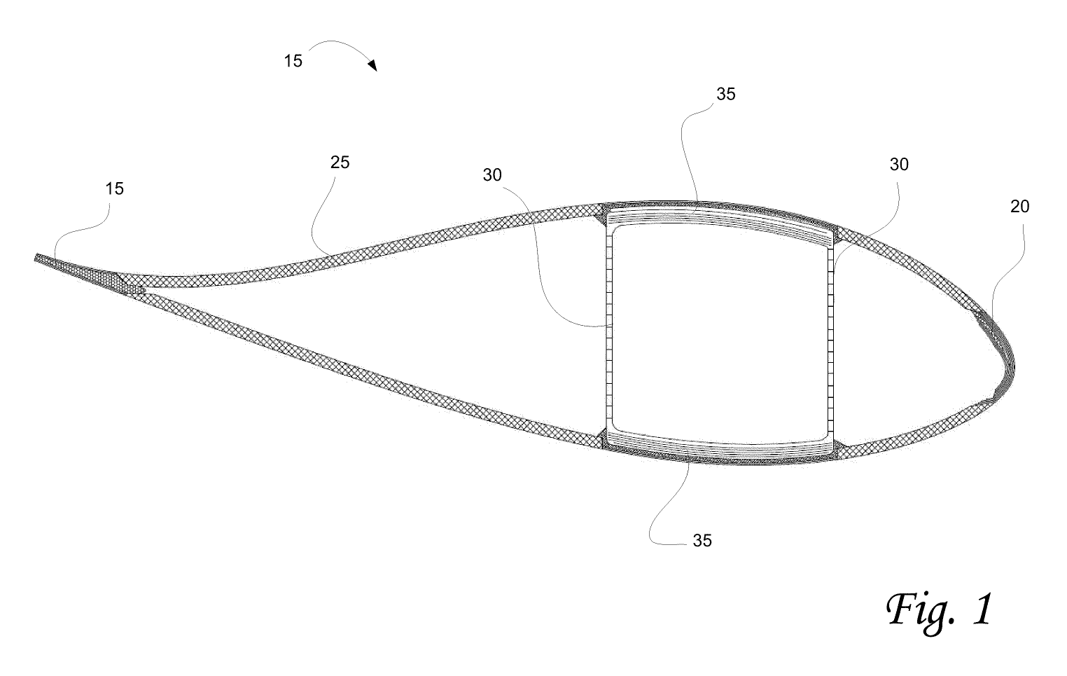

FIG. 1 illustrates a cross section of one example of a wind turbine blade 10 formed in accordance with the principles of the invention. The blade 10 comprises: a trailing edge 15; a leading edge 20; an aerodynamic shell section 25; a shear web 30; and a main beam section 35. In one example, the trailing and leading edges are formed of bonding paste and polyester infused material, the aerodynamic shell and shear web are formed from a polyester infused material and the main beam section is formed from laminations comprising vinyl ester prepreg.

In a variant, the wind turbine blade has laminations formed from vinyl ester prepreg. In another variant, referring to FIG. 1, the blade 10 comprises a main beam section 35 formed from vinyl ester prepreg. In a further variant, the wind turbine blade 10 has a root area formed from vinyl ester prepreg. In still another variant, the wind turbine blade comprises a main beam section 35 and a root area both formed from vinyl ester prepreg.

In yet a further variant of the wind turbine blade, only the laminations forming the main beam of the blade are formed from vinyl ester prepreg. In another variant, the remainder of the blade is produced by infusion with polyester resin.

In a further variant, the wind turbine blade has laminations formed from vinyl ester prepreg filler fibers having at least an 80% by weight proportion of the fibers oriented within 5 degrees greater or less than parallel to the blade axis. The blade axis points perpendicular to the cross section of FIG. 1.

In still another variant of the wind turbine blade, the vinyl ester prepreg material comprises between about 30% to about 70% of the total weight of the blade.

In a further variant, a process for forming a wind turbine blade comprises: curing a main beam of the blade formed form vinyl ester prepreg in a mold at a temperature in excess of one hundred degrees Celsius; and curing the rest of the blade not comprising the main beam in a larger mold below forty degrees C.

### EXAMPLES

### Example 1

A unidirectional plate was produced by filament winding onto a square mandrel. The thickness of the plate was 4.2 mm, and burnoff testing showed fiber content of 78% w/w. The resin used was Derakane Momentum 470-300, and the fiber was Hengshe 2400 tex E-glass roving. Magnesion Oxide was added at 0.5% as a thickening agent, Dicumyl Peroxide at 0.75% as a catalyst. Curing was done at 120° C. for 6 hours under vacuum bagging. After simulation of the prepregging and curing process, the produced plate was subjected to 90 degree tensile testing. The normal value for the tensile strength was found to be 33 MPA after testing 10 samples according to DIN EN ISO 527-5 Type B.

### Example 2

A unidirectional plate was produced by filament winding onto a square mandrel. Curing was done at 120° C. for 6 hours under vacuum bagging. The thickness of the plate was 4.2 mm, and burnoff testing showed fiber content of 78% w/w. The resin used was Derakane Momentum 470-300, and the fiber was Hengshe 2400 tex E-glass roving. Magnesium Oxide was added at 0.5% as a thickening agent, Dicumyl Peroxide at 0.75% as a catalyst. After simulation of the prepregging and curing process, the produced plate was subjected to 0 degree tensile testing, and the characteristic value of tensile E modulus was found to be 42,150 MPA, with characteristic strength of 830 MPA after testing 10 samples according to DIN EN ISO 527-5 Type A.

### Example 3

A unidirectional plate was produced by filament winding onto a square mandrel. The thickness of the plate was 4.2 mm, and burnoff testing showed fiber content of 78% w/w. The resin used was Derakane Momentum 470-300, and the fiber was Hengshe 2400 tex E-glass roving. Magnesion Oxide was added at 0.5% as a thickening agent, and Dicumyl Peroxide at 0.75% as a catalyst. After simulation of the prepregging and curing process (120° C. for 6 hours under vacuum bagging), the produced plate was subjected to 0 degree alternating fatigue testing, and the slope of the fatigue curve normal value was found to be 1:10.3 after testing at R=−1, and load levels of +/−600, 400, and 200 MPA.

### Example 4

A unidirectional plate was produced by winding prepreg as per example 3, aging for 24 hours at 30° C., then cutting from the mandrel and stacking until reaching 35 layers thickness, each with fiber areal weight of 1200+/−50 g/m2. This plate was cured for 6 hours at 120 degrees C. under vacuum. Afterward, the plate thickness was 28 mm+/−2 mm, fiber volume fraction was determined by burn off testing to be 77% w/w, and the plate exhibited good integrity and freedom from air inclusion.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. In addition, when a single callout line in the drawings leads to two or more separate reference numbers (first, second, etc. reference numbers), (and each reference numeral refers to a different piece of text in the detailed description) and it would be inconsistent to designate the drawing item being called out as both pieces of text, the drawing should be interpreted as illustrating two different variants. In one variant, the drawing item is referred to by the first reference number and in another variant the drawing item is referred to by the second reference number, etc.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A wind turbine blade having laminations formed from vinyl ester prepreg.

2. The wind turbine blade of claim 1, wherein the blade comprises a main beam section formed from vinyl ester prepreg.

3. The wind turbine blade of claim 1, wherein the blade comprises a root area formed from vinyl ester prepreg.

4. The wind turbine blade of claim 1, wherein the blade comprises a main beam section and a root area both formed from vinyl ester prepreg.

5. The wind turbine blade of claim 1, wherein only the laminations forming the main beam of the blade are formed from vinyl ester prepreg.

6. The wind turbine blade of claim 5, wherein only the laminations forming the main beam of the blade are formed from vinyl ester prepreg and the remainder of the blade is produced by infusion with polyester resin.

7. The wind turbine blade of claim 1, further comprising:
a blade axis;
wherein the laminations are formed from vinyl ester prepreg filler fibers having at least an 80% by weight proportion of the fibers oriented within 5 degrees parallel to the blade axis.

8. The wind turbine blade of claim 1, wherein the vinyl ester prepreg material comprises between about 30% to about 70% of the total weight of the blade.

9. A process for forming a wind turbine blade, comprising:
curing a main beam of the blade formed form vinyl ester prepreg in a mold at a temperature in excess of one hundred degrees Celsius;
curing the rest of the blade not comprising the main beam in a larger mold below forty degrees C.
